(19) United States
(12) Patent Application Publication
(10) Pub. No.: US 2004/0071401 A1
(43) Pub. Date: Apr. 15, 2004

(54) Effective refractive index chirped bragg gratings

(76) Inventors: Louay Eldada, Lexington, MA (US); Aaron Peer, Wilmington, MA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/425,476

(22) Filed: Apr. 29, 2003

Related U.S. Application Data
(60) Provisional application No. 60/376,288, filed on Apr. 29, 2002.

(51) Int. Cl. G02B 6/34

(52) U.S. Cl. 385/37; 385/43

(57) ABSTRACT

The present invention is directed to a novel method for preparing chirped Bragg gratings and optical communications devices fabricated therewith.

### FIELD OF THE INVENTION

The present invention is directed to a novel method for preparing chirped Bragg gratings, and optical communications devices fabricated therewith.

### BACKGROUND OF THE INVENTION

Fiber Bragg gratings are known in the art for use in adding or dropping light signals at predetermined centered wavelengths to or from a wavelength division multiplexed fiber optic transmission system which carries signals at other wavelengths. A thorough summary of the state of the art is provided in R. Kashyap, Fiber Bragg Gratings, Academic Press (1999).

A Bragg grating will reflect a narrow wavelength band selected from a broad band signal. The art teaches that the wavelength of light that is reflected in the grating system is determined in accordance with the formula

λ=2n_{eff}Λ

whereλ is the center point of the reflected wavelength range, n_{eff} is the effective refractive index of the waveguide, andΛ is the period of the grating.

It is further known in the art that an optical pulse of finite width will undergo chromatic dispersion, causing an undesirable broadening of the pulse. Chirped Bragg gratings are employed as chromatic dispersion compensators. Chirping is a gradual spatial change in the grating properties, causing slightly different wavelengths to be reflected at different points along the grating length.

It is clear from the above equation that the wavelength of the reflected light can be altered by either a change in the grating period, or by a change in the effective index of refraction of the waveguide medium in which the Bragg grating is disposed. Both methods have been taught in the art.

The first method is called period-chirping wherein the spacing of adjacent areas of high and low refractive index gradually changes along the direction of propagation. The second method is called effective-index-chirping. In this method, the grating period remains uniform, but the average effective refractive index of the medium is altered.

The production of the chirping effect in fiber Bragg gratings by variation in the effective refractive index is disclosed in Byron et al., Electron. Lett. 29, (18) 1659 (1993). The variation is accomplished by tapering of waveguide dimensions. Linear gratings are written in the tapered waveguide to achieve the chirped effect.

Hill et al, Tech. Dig. of Post Deadline Pap., PD-21, Opt. Fib. Comm. Conf. OFC, '94 disclose varying the refractive index along the length of a uniform period grating.

Apodized and non-apodized chirped Bragg gratings are known, Kashyap, op. cit., §7.2.1. Apodization involves a controlled alteration of the amplitude of certain lines in the Bragg grating in order to minimize the effect of side lobes in the reflected signal.

Use of a phase mask for the preparation of uniform-period Bragg gratings in polymeric waveguides is disclosed in Eldada et al, U.S. Pat. No. 6,023,545.

U.S. Pat. No. 5,982,963 discloses chromatic dispersion compensation by use of a chirped Bragg grating both with and without the incorporation of a circulator. Tunability is achieved by the application of strain, an electric field, electromagnetic radiation, or acoustic waves to the waveguide structure. The Bragg gratings disclosed are chirped by virtue of a period change along the grating.

U.S. Pat. No. 6,317,539 discloses a cascade of chromatic dispersion compensators based on sampled Bragg gratings. Use of chirped Bragg grating—with or without incorporation of a circulator—is disclosed. The Bragg grating is chirped by virtue of a period change along the grating. Further disclosed is compensation of both chromatic dispersion and the slope of the dependence of chromatic dispersion on wavelength.

U.S. Pat. No. 6,330,383 discloses a tunable chromatic dispersion compensator and a tunable dispersion slope compensator, the compensators comprising chirped Bragg gratings tuned by the application of strain, electric field, electromagnetic radiation, or acoustic waves.

Fritze et al, SOI Conference, IEEE International 2002, 165-166 (2002) disclose gray tone imaging for shaping optical communications components. Gray-scale masks are disclosed therein.

Matsumoto et al, IEEE Photonics Technology Letters, 13 (8), 827-829 (2001) disclose chromatic dispersion slope compensation by application of a parabolic index profile to fiber Bragg gratings. Their method does not provide simultaneous dispersion compensation and dispersion slope compensation.

### SUMMARY OF THE INVENTION

The present invention provides an effective-refractive-index-chirped Bragg grating comprising a tapered polymeric optical waveguide, a substrate and a Bragg grating of uniform periodicity disposed within said waveguide, said waveguide being disposed on said substrate.

The present invention further provides for a method for preparing a chirped Bragg grating, the method comprising the application of a temperature gradient to a Bragg grating having uniform periodicity.

The present invention further provides a method for preparing a chirped Bragg grating, the method comprising gray-scale exposure of a photorefractive optical waveguide followed by preparation therewithin of a uniform-period Bragg grating.

The present invention further provides for an apparatus which simultaneously provides combined chromatic dispersion compensation and chromatic dispersion slope compensation comprising a uniform-period Bragg grating, a substrate, a first heater disposed between said uniform-period Bragg grating and said substrate, and a second heater disposed on a side of said chirped Bragg grating opposite to said first heater, one of said heaters comprising an essentially parabolic shape (in width or thickness) and the other of said heaters providing an essentially trapezoidal profile (in width or thickness), said heaters being disposed such that upon activation to provide heat, both a parabolic temperature profile and a linear temperature profile will be superposed upon said uniform-period Bragg grating.

The present invention further provides an apparatus that provides polarization-independent chromatic dispersion or chromatic dispersion slope compensator comprising a polarization eigenmode splitter/combiner and two chromatic dispersion or chromatic dispersion slope compensators.

### BRIEF DESCRIPTION OF THE FIGURES

FIG. A: Shows, schemicatically, a cascade of compensators, each of the compensators compensating a sub-band of a broad spectral band.

FIG. B: Shows a circulator added to physically separate the original incoming signal and the compensated outgoing signal into separte optical paths.

FIG. 1: A module consisting of a number of CDC's where each provides chromatic dispersion compensation to a sub-band of the entire wavelength band of interest, and where said CDC's are placed between a demultiplexer and a multiplexer, said module providing chromatic dispersion compensation to the entire band of interest.

FIG. 2: A module consisting of a number of CDC's where each provides chromatic dispersion compensation to a sub-band of the entire wavelength band of interest, and where said CDC's are combined with a component that acts as a demultiplexer for the incoming signal and a multiplexer to the outgoing compensated signals, said module providing chromatic dispersion compensation to the entire band of interest.

FIG. 3: A module similar to the module of FIG. 2, with the addition of an optical circulator that allows the incoming signal and the outgoing compensated signal to use separate ports, making the output signal readily accessible and usable.

FIG. 4: A tunable CDC consisting of a period-chirped Bragg grating and an essentially linear heater used for tuning. A representation of the current state of the art. Heaters shown as rectangular heaters in the figures herein represent linear heaters that can be uniform or can have an essentially linearly tapered thickness or width. This drawing convention is used to differentiate the relatively mildly tapered heaters used for tuning the compensation of the chromatic dispersion or the chromatic dispersion slope, from the more aggressively tapered heaters used for chirping gratings (and possibly additionally tuning the compensation of the chromatic dispersion or the chromatic dispersion slope).

FIG. 5: A tunable CDC consisting of a heater-chirped Bragg grating. While aggressively-tapered heaters used for chirping Bragg gratings are presented herein as having an essentially linearly tapered width (or essentially trapezoidal), said heaters can alternately have an essentially linearly tapered thickness.

FIG. 6: A tunable CDC consisting of an effective-refractive-index-chirped Bragg grating and an essentially linear heater used for tuning. The effective refractive index can be varied by varying the dimensions or the indices of the waveguide.

FIG. 7: A tunable CDC consisting of a chirped Bragg grating and two heaters, where one heater is used to compensate the chromatic dispersion, and the other heater is used to compensate the chromatic dispersion slope. In a preferred integrated optic embodiment, one of the heaters is above the waveguide and the other heater is below the waveguide. In another preferred embodiment, the chromatic dispersion slope compensation heater has an essentially parabolically varying profile.

FIGS. 8-11: Similar to FIGS. 4-7 with the grating being apodized (the envelope of the refractive index is not uniform, said amplitude being larger at some point along the grating, typically around the middle of the grating, and gradually becomes smaller towards the extremities). This apodization minimizes spectral sidelobes in the response of the grating.

In the CDC designs of FIGS. 4-11, the incoming signal and the outgoing compensated signal share the same port, as Bragg gratings are reflective.

FIG. 12: A CDC consisting of a single chirped Bragg grating, where an optical circulator is used to allow the incoming signal and the outgoing compensated signal to use separate ports, making the output signal readily accessible and usable. Having the incoming signal and the outgoing compensated signal for each CDC use separate ports is not always needed, as in the modules of FIG. 2 and 3, where it is desirable to have both signal share the same port in order to use the demultiplexer as a multiplexer as well. Separating the final multiplexed output signal from the incoming signal can then be done with a single optical circulator, as in FIG. 3.

FIG. 13: A CDC that mitigates the problem of the two polarization eigenmodes being treated differently in the dispersion compensation operation (e.g., if the grating is significantly birefringent). In this embodiment, the use of a polarization mode splitter/combiner allows the two polarization eigenmodes to be sent to two separate CDC's that dispersion compensate each mode separately.

FIG. 14: Shows one embodiment of a Bragg grating 2 that includes a substrate 4 having thereon an undercladding layer 6 and an overcladding layer 8. Sandwiched between the cladding layers 6 and 8 is a core layer 10.

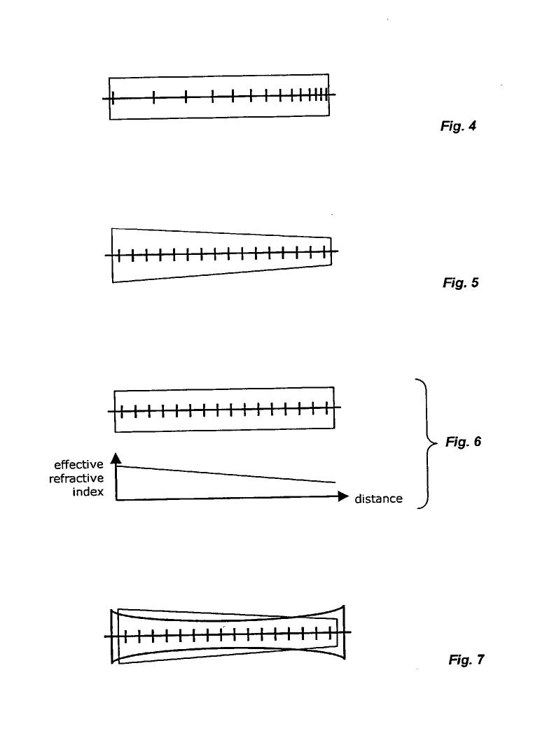

In the FIGS. 4-13 above a central straight horizontal dark line is employed to indicate an optical waveguide. Vertical dashes are employed to indicate schematically the grating lines, while varying dash length indicates varying-amplitude index oscillation. The combination of grating lines and a waveguide constitute a Bragg grating. Boxes around the gratings in the form of rectangles, trapezoids, or “bowtie” boxes with parabolically varying profiles are employed to schematically indicate heaters. In actual practice, heaters may be disposed in a number of different ways with respect to the Bragg grating.

### DETAILED DISCUSSION OF THE INVENTION

In accordance with the present invention, a Bragg grating in the form of an optical waveguide deposited upon a substrate is provided. The substrate employed for fabrication of the Bragg grating of the present invention can be selected from a variety of materials including glass, silicon, and plastics such as polyurethane and polycarbonate. As shown in FIG. 14, one embodiment of a Bragg grating 2 includes the substrate 4 as defined above having thereon an undercladding layer 6 and an overcladding layer 8. Sandwiched between the cladding layers 6 and 8 is a core layer 10.

The undercladding layer 6, the overcladding layer 8 and the core layer 10 are made from photorefractive materials—materials that exhibit a change in refractive index proportional to the intensity of UV light to which they are exposed. Preferred photorefractive materials are polymers comprising comonomers selected so as to have indexes of refraction which are different from each other.

Suitable comonomers exhibit different diffusion rates such that one of the monomers has a tendency to move away from the fringes of an incident light beam during grating fabrication according to the methods of the art, preferably that in Eldada et al, op.cit., which is incorporated herein by reference to the entirety, while another monomer will tend to remain. It is desirable that the comonomers that remain under exposure to the light undergo rapid polymerization rate while those monomers that are not in the light fringes undergo polymerization more slowly.

Polymers preferred for the practice of the invention are cross-linked polymethacrylates prepared from at least two diacrylate monomers. Preferred diacrylate monomers are selected from the group consisting of ethoxylated bisphenol diacrylate (EBDA), tripropylene glycol dacrylate, 1,6, hexanediol diacrylate (HDDA), ethoxylated bisphenol dimethacrylate, 1,6 hexanediol dimethacrylate, and halogenated dimethacrylates. Most preferred are fluorinated dimethacrylate monomers.

In the practice of the invention in accord with the discussion hereinabove, certain combinations of monomers are favored over others. For example, HDDA monomer that polymerizes rapidly, and EBDA that polymerizes more slowly than HDDA, represent a preferred pair of monomers.

One of skill in the art will appreciate that in any of the embodiments of the present invention, the Bragg grating may be apodized or not according to the dictates of the particular application for which it is intended.

In one embodiment of the present invention is provided a chirped Bragg grating comprising a tapered polymeric waveguide chip, said waveguide exhibiting a taper in one dimension only, and a Bragg grating of uniform periodicity disposed within said waveguide according to the methods of the art.

Bragg gratings of the art that are chirped by effective index variation comprise a conically tapered glass fiber that has been subject to UV light sent through a phase mask. While the period of the refractive index oscillation thereby induced is uniform, the amplitude of the oscillations is not uniform because the sites inherent in the glass fiber that allow index change have been spread apart by the stretching of the fiber necessary to create the taper. Furthermore, stress-induced birefringence is likely to arise from the stretching of the fiber, resulting in behavior that is polarization-dependent, a highly undesirable result. From a practical viewpoint, a Bragg grating chirped in the manner of the art offers considerable difficulty in design and reproducibility.

A tapered, preferably polymeric, waveguide on a chip is prepared directly in tapered form according to the various photolithographic and other methods such as are known in the art therefor. In such a tapered preferably polymeric waveguide, the waveguide composition is uniform throughout the waveguide. There is only dimensional variation, and no concomitant variation in the index oscillation amplitude. Furthermore, a “printed” tapered waveguide on a chip does not undergo stress in forming the taper, thereby minimizing birefringence. Further, the process for preparing a tapered preferably polymeric waveguide permits forming a waveguide of arbitrary cross-sectional shape, according to the requisites of the application.

In another embodiment, the present invention provides a method for preparing a chirped Bragg grating, the method comprising the application of a temperature gradient to a Bragg grating having uniform periodicity. It is well-known in the art that optical materials exhibit a dependency of refractive index upon temperature. However, in the art linear heating is applied to tune a period-chirped Bragg grating. An embodiment of the known art is depicted schematically in FIG. 4. It is found surprisingly in the practice of the present invention that the application of a temperature gradient by the use of a tapered heating profile to a uniform-period Bragg grating is a highly effective way to create a tapered effective index profile adequate to form a chirped Bragg grating. One embodiment of this invention is depicted in FIG. 5.

Of course, linear heating can also be applied to tune a chirped Bragg grating having uniform periodicity and a varying effective index profile produced by a non-heating means.

Preparing an effective index profile by heating a uniform period Bragg grating may be accomplished on essentially any waveguide material including glass, silicon, or plastic. It is preferable to employ a waveguide material having a relatively high sensitivity of refractive index to temperature in order to expand the range of tunability. Plastic is preferred.

A heating profile may be applied to a uniform-period Bragg grating by any means known in the art. The profile is preferably continuous, but may exhibit one or more discontinuities. A preferred method is simply a tapered profile heater wherein the direction of the taper is longitudinal along the waveguide.

In a preferred embodiment, the effective-refractive-index-chirped Bragg grating of the invention comprises a substrate, a uniform-period Bragg grating disposed in a polymeric waveguide consisting of a core and a cladding, and a heating means, said heating means disposed between said substrate and said optical waveguide, said heating means being disposed or shaped to provide a continuous or semi-continuous temperature gradient within said optical waveguide. The effective-refractive-index gradient is activated by the application of heat by the heating means. Most preferably, there is an insulating layer between said heating means and said substrate. Said heating means is preferably an electrical resistance heater.

In a further embodiment of the present invention is provided a method for preparing a chirped polymeric Bragg grating, the method comprising gray-scale exposure of a photorefractive optical waveguide prior to the preparation of a uniform-period Bragg grating according to the art. The photoreactive materials suitable for use in this embodiment are the same as described hereinabove.

In this embodiment, a gray-scale mask is prepared according to methods known in the art for preparing photomasks. Photomasks are typically prepared so that any given region is either completely transparent or completely opaque, thereby producing lines on the illuminated substrate which are either dark or bright. By contrast, a gray scale mask is prepared so that there is a continuous or semi-continuous gradation in the transparency of the mask so that the incident light on the exposed substrate ranges continuously in intensity. In the practice of the present invention, the gray-scale mask through which the light source passes into the polymeric material can be selected from a variety of materials including glass and quartz.

According to the present invention, an optical waveguide comprising a photorefractive material is subject to gray-scale illumination, thereby inducing a continuous gradation in refractive index thereof. Following exposure to the gray-scale illumination, the thus exposed optical waveguide is then subject to treatment to prepare therewithin a uniform-period Bragg grating. A preferred method for preparing the Bragg grating of the present embodiment is that of Eldada et al, op. cit.. The result is an effective-refractive-index chirped uniform period waveguide according to the present invention.

When an effective-indexprofile is created within the optical waveguide by non-thermal means as herein described, one embodiment of the present invention encompasses the use of a linear heater to provide tunability to the effective-refractive-index-chirped Bragg grating, as depicted schematically in FIG. 6.

The embodiments of the present invention hereinabove described are directed to chromatic dispersion compensation in a Bragg grating by the application of effective-refractive-index chirping in a uniform-period Bragg grating. In all such embodiments, the refractive index profile is a monotonic function of distance along the length of the grating. The profile may be monotonically increasing or decreasing.

It is well known in the art that dispersion is not constant with wavelength; signals at different wavelengths are smudged to different degrees as they travel down the fiber. Optical signals that are modulated very fast have a broader spectral width, with the result that they cannot be adequately compensated using a single value of dispersion. And the problem gets worse as speeds increase. For example, a 40 Gbit/s signal has a typical spread of 0.64 nanometers. At four times the speed, this spread gets four times wider, becoming 2.56 nanometers. With chromatic dispersion compensation, but without slope compensation, 160-Gbit/s signals are still too distorted to read. Adding in a dispersion slope compensator solves the distortion problem.

In order to achieve adequate dispersion compensation for high-speed data transmission, it is necessary to compensate for the wavelength dependence of chromatic dispersion, or, to use a term of art, dispersion slope compensation. It is known in the art to effect compensation for dispersion slope by applying a quadratic chirp profile in a Bragg grating.

In an alternative embodiment of the present invention, a uniform-period Bragg grating may be applied to an optical waveguide having a quadratic effective-refractive-index profile prepared according to any of the processes described hereinabove.

A quadratic-refractive-index-profile-chirped Bragg grating can be combined with heating to provide tunability.

In a particularly preferred embodiment of the present invention is provided a combined chromatic dispersion compensator and chromatic dispersion slope compensator comprising a chirped Bragg grating, a substrate, a first heater disposed between said chirped Bragg grating and said substrate, and a second heater disposed on a side of said chirped Bragg grating opposite to said first heater, one of said heaters being of a “bow-tie” shape (in width or in thickness) to effect a quadratic effective refractive index profile, and one of said heaters being of a continuously tapered trapezoidal shape (in width or in thickness) to effect a monotonic refractive index profile. The resulting superposition of the two thermal effects provides both chromatic dispersion compensation and chromatic dispersion slope compensation. This embodiment is depicted schematically in FIG. 7.

In a further embodiment of the present invention is provided a polarization-independent chromatic dispersion or chromatic dispersion slope compensator comprising a polarization eigenmode splitter/combiner and two chromatic dispersion or chromatic dispersion slope compensators prepared according to the present invention. In the present embodiment, the two polarization eigenmodes of an incoming signal are separated using a polarization splitter/combiner such as is well known in the art. Each polarization eigenmode is then compensated by a separate compensator. The two reflected separately compensated polarization eigenmodes are then recombined using the polarization splitter/combiner.

In the chirped Bragg gratings of the present invention, the two polarization eigenmodes have different effective refractive index values. The present embodiment of the invention compensates for the polarization dependence of the chromatic dispersion compensation resulting therefrom.

The same technique can be applied to any chirped Bragg grating regardless of the manner of chirping or the method of fabrication. This is depicted schematically in FIG. 13.

One of skill in the art will appreciate that numerous specific uses and configurations are contemplated for the effective-refractive-index chirped Bragg gratings prepared according to the present invention. Some of these are depicted in the figures. These include a cascade of compensators, each of said compensators compensating a sub-band of a broad spectral band as depicted schematically in Figure A. A circulator can be added to physically separate the original incoming signal and the compensated outgoing signal into separate optical paths as depicted schematically in Figure B.

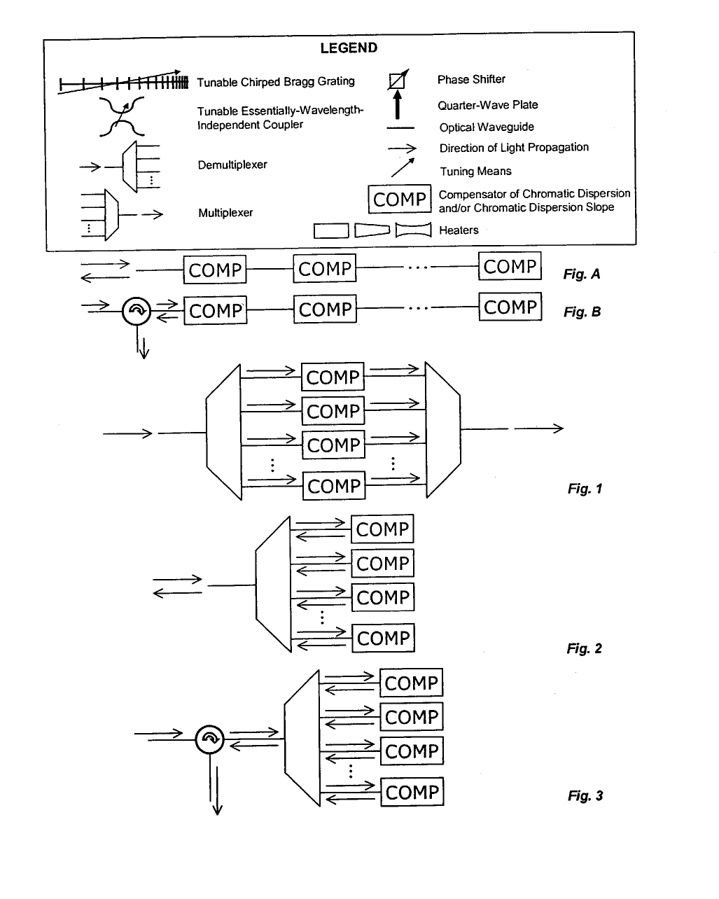

Use of demultiplexers to separate a broadband optical signal into narrower band channels and directing each said channels to a compensator as depicted schematically in FIG. 1.

Use of a demultiplexer to separate a broadband optical signal into separate channels for compensation and then recombining the reflected compensated signals into a multiplexed signal once again, as depicted schematically in FIG. 2.

Incorporation of a circulator to physically separate the original incoming signal and the compensated outgoing signal into separate optical paths as depicted schematically in FIG. 3.

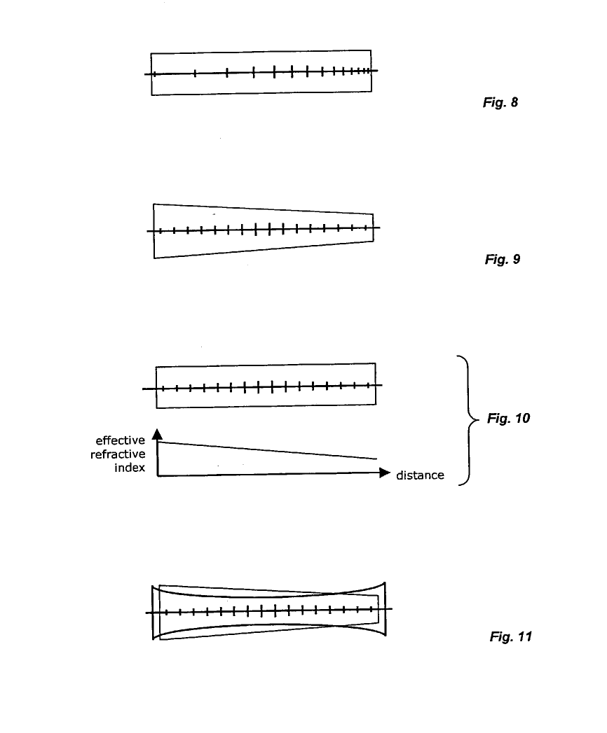

Tunable compensators such as are depicted in FIGS. 5-7, but with the addition of apodization, as depicted schematically in FIGS. 8-11.

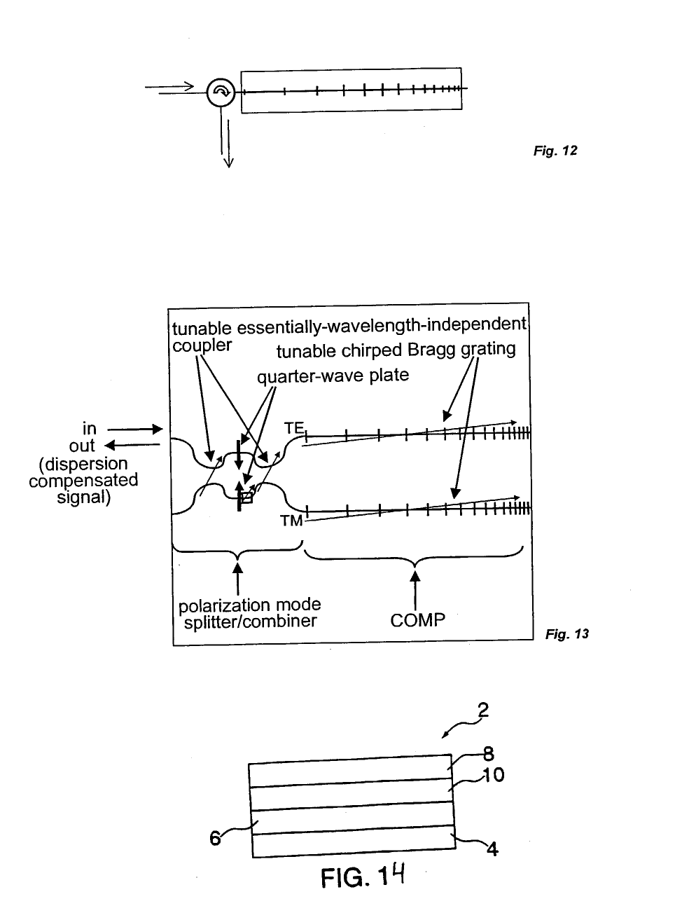

An apparatus consisting of any tunable compensating device as depicted in FIGS. 5-11, wherein a single compensator covers the entire spectral range to be compensated and a circulator is incorporated to physically separate the original incoming signal and the compensated outgoing signal into separate optical paths as depicted schematically in FIG. 12.

The invention is further described in the following example

### EXAMPLE

The following terms are employed:

ARC is a mixture of 31.5% by weight of di-trimethylolpropane tetraacrylate, 63% by weight of tripropylene glycol diacrylate, 5% by weight of bis-(diethylamine) benzophenone, and 0.5% by weight of Darocur 4265.

B3 is a mixture of 94% by weight of ethoxylated perfluoropolyether diacrylate (MW1100), 4% by weight of di-trimethylolpropane tetraacrylate, and 2% by weight of Darocur 1173.

BF3 is a mixture of 98% by weight of ethoxylated perfluoropolyether diacrylate (MW1100) and 2% by weight of Darocur 1173.

C3 is a mixture of 91% by weight of ethoxylated perfluoropolyether diacrylate (MW1100), 6.5% by weight of di-trimethylolpropane tetra-acrylate, 2% by weight of Darocur 1173, and 0.5% by weight of Darocur 4265.

A 6-inch oxidized silicon wafer (substrate) is cleaned with KOH, then treated with (3-acryloxypropyl)trichlorosilane. A 17-μm-thick layer of B3 monomer is spin-deposited on the wafer, then polymerized with UV light. Successive layers of Cr, Au, and Cr are sputter deposited onto the polymer-coated wafer at respective thicknesses of 10/200/10 nanometers to form a heater stack. A 20 nanometer thick layer of SiO₂ is deposited on the bottom heater stack as an adhesion layer. A 6-μm-thick layer of ARC antireflection coating is deposited onto the silica layer. Polymer waveguides are formed on said ARC using negative-tone photosensitive monomers in the following way: a 10-μm-thick BF3 underclad layer is spin-deposited and blanket cured with UV light, a C3 core layer is deposited and 7-μm×7-μm-cross-section straight waveguides are patterned in it by shining UV light through a dark-field photomask then developing the unexposed region with an organic solvent, and a 10-μm-thick B3 overclad layer is spin-deposited and blanket cured with UV light. A uniform Bragg grating is formed in each of said waveguides by UV exposure through a phase mask. A 100-nanometer Ni layer is sputter-deposited and patterned photolithographically as a mask for RIE. Said waveguides are patterned using reactive ion etching (RIE) to form around them mesa structures of parabolically-varying profiles that are larger at the extremities (the shape of the desired bottom heater), exposing between them the heater stack of Cr/Au/Cr. The Nickel RIE mask and Cr between mesas are completely etched, leaving a Cr/Au layer between the mesas. The wafer is electroplated with Au, using the mesas as the plating mask. Trapezoidal top heaters (narrow at one end of the grating, wider at the other end, in width or in thickness) are formed on top of the mesas by sputter-depositing a 10/200 nanometer stack of Cr/Au and patterning said stack photolithographically. When electrical power is applied to said trapezoidal heaters, the average effective refractive index in the grating varies along the grating due to the varying temperature of the heater caused by the varying shape of said heater, causing the Bragg grating to be thermally effective-refractive-index-chirped. A 100 nm Ni layer is subsequently sputter-deposited and patterned photolithographically as a mask for RIE. Said mesas are further RIE etched from both lateral sides, exposing the underlying Cr/Au/Cr. Said Ni RIE mask and Cr between mesas and plated runs are completely etched, leaving a Cr/Au layer between the mesas, which is patterned photolithographically to isolate the resulting tunable chromatic dispersion / dispersion slope compensation optical components.

What is claimed is:

1. An effective-refractive-index-chirped Bragg grating comprising a tapered polymeric optical waveguide, a substrate and a Bragg grating of uniform periodicity disposed within said waveguide, said waveguide being disposed on said substrate.

2. The grating of claim 1 wherein said polymeric optical waveguide comprises halogenated methacrylate monomer units.

3. The grating of claim 2 wherein said halogenated methacrylate is a fluorinated methacrylate.

4. A method for preparing a chirped Bragg grating, the method comprising the application of a temperature gradient to a Bragg grating having uniform periodicity.

5. The method of claim 4 wherein said Bragg grating is polymeric.

6. The method of claim 5 wherein said polymeric grating comprises halogenated methacrylate monomer units.

7. The method of claim 6 wherein said halogenated methacrylate is a fluorinated methacrylate.

8. The method of claim 4 further comprising use of a heater of tapered profile in width or in thickness to provide said temperature gradient.

9. A method for preparing a chirped Bragg grating, the method comprising gray-scale exposure of a photorefractive optical waveguide followed by preparation therewithin of a uniform period Bragg grating.

10. The method of claim 9 wherein said optical waveguide is polymeric.

11. The method of claim 10 wherein said optical waveguide comprises halogenated methacrylate monomer units.

12. The method of claim 11 wherein said halogenated methacrylate is a fluorinated methacrylate.

13. An apparatus which simultaneously provides combined chromatic dispersion compensation and chromatic dispersion slope compensation comprising a uniform-period Bragg grating, a substrate, a first heater disposed between said uniform-period Bragg grating and said substrate, and a second heater disposed on a side of said chirped Bragg grating opposite to said first heater, one of said heaters comprising an essentially parabolic shape in width or in thickness, and the other of said heaters providing an essentially trapezoidal profile in width or in thickness, said heaters being disposed such that upon activation to provide heat, both a parabolic temperature profile and a linear temperature profile will be superposed upon said uniform-period Bragg grating.

14. The apparatus of claim 13 wherein the heaters are electrical resistance heaters.

15. The apparatus of claim 13 wherein said uniform-period Bragg grating comprises a polymeric optical waveguide.

16. The apparatus of claim 15 wherein said polymeric optical waveguide comprises halogenated methacrylate monomer units.

17. The apparatus of claim 16 wherein said halogenated methacrylate is a fluorinated methacrylate.

18. An apparatus that provides polarization-independent chromatic dispersion or chromatic dispersion slope compensator comprising a polarization eigenmode splitter/combiner and two chromatic dispersion or chromatic dispersion slope compensators.

19. The apparatus of claim 18 wherein at least one said chromatic dispersion compensator is a chirped Bragg grating.

20. The apparatus of claim 19 wherein said chirped Bragg grating is an effective-refractive-index-chirped uniform-period Bragg grating.

21. The apparatus of claim 20 wherein said Bragg grating comprises a polymeric optical waveguide.

22. The apparatus of claim 21 wherein said polymeric optical waveguide comprises halogenated methacrylate monomer units.

23. The apparatus of claim 22 wherein said halogenated methacrylate is a fluorinated methacrylate.

24. An apparatus for multiplexing and/or demultiplexing an optical signal, the apparatus comprising a chromatic dispersion compensator or chromatic dispersion slope compensator, said compensator comprising an effective-refractive-index-chirped uniform-period Bragg grating.

25. The apparatus of claim 24 further comprising a circulator.

26. The apparatus of claim 24 or claim 25 wherein said Bragg grating comprises a polymeric optical waveguide.

27. The apparatus of claim 26 wherein said polymeric optical waveguide comprises halogenated methacrylate monomer units.

28. The apparatus of claim 27 wherein said halogenated methacrylate is a fluorinated methacrylate.
